(19) United States
(12) Patent Application Publication
(10) Pub. No.: US 2010/0003641 A1
(43) Pub. Date: Jan. 7, 2010

(54) Dental crown system

(76) Inventors: John P. Hansen, Roseville, CA (US); Jeffrey P. Fisher, Sacramento, CA (US)

Correspondence Address: LAW OFFICES OF IRA D. BLECKER, P.C., 206 KINGWOOD PARK, POUGHKEEPSIE, NY, 12601, US

(21) Appl. No.: 12/228,783

(22) Filed: Aug. 14, 2008

Related U.S. Application Data
(60) Provisional application No. 60/964,912, filed on Aug. 15, 2007.

(51) Int. Cl. A61C 5/08

(52) U.S. Cl. 433/218; 433/222.1

(57) ABSTRACT

A system for providing a dental crown of substantially pure zirconia. The zirconia crown may be formed by one of several manufacturing process. The formed crown exterior is polished and fine polished to produce an aesthetic outer surface mimicking a natural tooth.

### CROSS-REFERENCES TO RELATED APPLICATIONS

The present application relies on and claim the benefit of prior filed provisional application 60/964,912, filed 15 Aug. 2007.

### BACKGROUND OF THE INVENTION

The present invention relates to a novel and useful prefabricated pedodontic crown.

At present, crowns used to repair teeth are custom fabricated according to a mold of a tooth being repaired which is provided by the dental practitioner. At present, crowns may be formed of stainless steel or metal cladded with porcelain. Specifically, molds of a particular tooth created by the dental practitioner serve a model for the finished crown. Computer software, through a CAD/CAM technology, then directs a milling machine to mill a coping or framework of the crown out of a chosen material, that is eventually cladded with porcelain. Although satisfactory in result, the patient receiving such a crown to repair a tooth must make multiple visits to the dental office to achieve this result. This process is time-consuming and expensive, especially where the tooth being replaced is a child's (baby) tooth which will eventually be lost and replaced by permanent teeth through the natural maturing process. Veterinary crowns are also produced in the same manner. Moreover, pediatric or pedodontic crowns have typically been formed of stainless steel and plastic. Such a system of pedodontic crowns suffers from problems of non-uniformity, (bulkiness), and lack of durability. In addition, disinfection of stainless steel/plastic crowns is difficult to achieve due to susceptibility to damage from steam and chemicals.

Zirconia formulations have been used in dentistry for several years for the manufacturing of crown coping or frameworks. The copings are typically layered with porcelain to build up the entire structure of the tooth restoration and to develop the esthetic surface characteristics. Zirconia has also been used for implant abutments and as endosseous implant cylinders. In the past, zirconia material has been considered as too expensive for use/as dental crowns also, the natural coloration of finished zirconia was deemed as too bright, not matching the appearance of a natural tooth.

Dental crowns and impression systems of various sorts have been proposed in the past.

For example, U.S. Pat. No. 6,769,913 describes a device for taking dental impressions. The device includes impression cap having an injection port configured to receive material in an inner cavity.

U.S. Pat. No. 4,492,579 shows a dental crown substrate formed of a noble-based metal formed over a thin metal foil substrate. A veneering material such as porcelain is then coated over the substrate.

U.S. Pat. Nos. 4,992,049, 5,314,335, and 5,538,429 teach dental crowns utilizing a base of metallic mesh or stranded material covered by a veneer of porcelain.

U.S. Pat. Nos. 3,058,216, 3,375,582, 4,392,829, 4,846,718, and 6,106,295 describe dental crowns utilizing metal or plastic as a coping which is veneered by porcelain or plastic material.

U.S. Pat. No. 6,663,390 illustrates a ceramic prosthesis in which a metallic core is provided for attachment to an implant in the patient's mouth. A ceramic crown of porcelain zirconia, or polymeric material then covers the extending metallic core.

U.S. Pat. No. 1,609,549 shows a telescopic tooth crown in which the interior of the crown includes a number of indents to aid in the adhesion of the inner and outer shells of the crown.

United States Patent Publication US2006/0154211 describes a pediatric crown which may be prefabricated in various sizes and shapes for primary dentition. Porcelain has been employed as a outer crown material due to esthetically appeal.

U.S. Pat. No. 6,638,069 shows a shaping cap using a matrix material including fillers such as zirconia mixed with silica and titanium dioxide.

A pre-fabricated strong pedodontic crown and process for making the same would be a notable advance in the dental field.

### BRIEF SUMMARY OF THE INVENTION

In accordance with the present a novel and useful pedodontic crown system is herein provided.

The system of the present invention utilizes substantially pure zirconia (ZrO2) to create a strong crown. Zirconia is usually found in a green or soft chalky state. Thus, zirconia, may be placed in a mold to form the general shape of a crown and, subsequently, hardened by sintering described below. Of course, the zirconia crown may also be formed by designing in CAD (Computer Aided Design) followed by milling of hardened zirconia, which may be stabilized by chemical entities. Such yttria, ceria, india and the like. In addition, electrophortic deposition may be employed to form the zirconia crown through the use of nanoparticles, alone, or in combination with the above methods. In the case of a pedodontic crown, various sizes may be pre-fabricated according to the most commonly used crowns for children. In addition, the interior surface of the crown, when molded, would include holes or pits which eventually will receive cementitious material to bond the crown to the stub of the natural tooth via a known process.

Following molding, the zirconia crown or crowns are placed in a sintering furnace to heat the same to approximately 1,000 degrees centigrade at several atmospheres pressure. Once the sintering process has been completed, the zirconia crown possesses a strength of approximately 900-1100 Mpa. This strength level compares to the strength of cast metal. The crown cavity is then created by milling. In addition, zirconia possesses a fairly, although not perfect, natural white color. However, the zirconia crown prepared as described above may be further amplified esthetically to closely match dental teeth by creating a pearlescent outer surface. Such a result is achieved by pre-polishing the external surface of the cast zirconia crown with a diamond impregnated silicon wheel. A final polish is then accomplished by a brush wheel with the application of a diamond paste prior to placement in a patient.

After the crown has been created, crowns of various sizes may be placed in a kit for use by the dental practitioner. In this regard, the practitioner follows standard preparation guidelines for primary dentition for placement of a pre-fabricated crown. Thus, a pedodontic crown may be installed or placed on a natural tooth in a single visit simply by preparing the tooth stub, and selecting a proper size of a pre-fabricated zirconia crown by its mesodistal width. The selected crown is then evaluated for fit and possible tissue impingement. Any extension of gingival margin is then trimmed where necessary with a fine diamond at relatively so speed and with copious water spray. The crown is then filled with glass ionomer or self curing composite resin cement. The crown is then seated in the mouth completely. It should be noted, that the pits or holes molded into the zirconia crown greatly aid in the fixing of the same to the stub of the natural tooth. Following such seating, the orientation of the crown is checked and, if necessary the occlusion is adjusted using a fine diamond. The emplaced crown is as hereinabove described mimics a natural tooth in appearance.

It should be realized that a new and useful dental crown system has been hereinabove described.

It is therefore an object of the present invention to provide a pedodontic crown system which is simple to use and easy to manufacture.

Another object of the present invention is to provide a pedodontic crown system in which the crown is solely formed of zirconia or similar material and greatly mimics the natural tooth appearance of a patient.

Another object of the present invention is to provide a pedodontic crown system in which a zirconia crown is employed that possesses great strength and durability.

Yet another object of the present invention is to provide a dental crown system which may be employed in veterinary applications.

Yet another object of the present invention is to provide a zirconia dental crown system which is suitable for use with front and rear natural teeth.

Another object of the present invention is to provide a dental crown composed solely of zirconia whose outer surface has been altered to closely resemble the appearance of a natural tooth.

A further objective of the present invention is to provide a pedodontic dental crown which over comes the problems of durability, non-uniformity, and the like of prior pedodontic dental crowns.

The invention possesses other objects and advantages especially as concerns particular characteristic and features thereof which will become apparent as specification continues.

### BRIEF DESCRIPTION OF THE SEVERAL VIEWS OF THE DRAWING

FIG. 1 is a side elevational view of the dental crown of the present invention with a directional arrow indicating its installment on a tooth stub.

FIG. 2 is a top plan view of the dental crown of the present invention.

FIG. 3 is a sectional view of another embodiment of the dental crown of the present invention.

FIG. 4 is a block diagram depicting the general process for creating a zirconium crown.

FIG. 5 is a top plan view of a kit having pedodontic crowns of various sizes which may be employed through a process selection.

For a better understanding of the invention reference is made to the following detailed description of the preferred embodiments of the invention which should be taken in conjunction with the above described drawings.

### DETAILED DESCRIPTION OF THE PREFERRED EMBODIMENTS OF THE INVENTION

Various aspects of the present invention will evolve from the following detailed description of the preferred embodiments thereof which should be referenced to the prior described drawings.

The invention as a whole is shown in the drawings by reference character 10. The pedodontic crown 10 is intended to fit over the stub 12 of a natural tooth and is placed in that position according to directional arrow 14. Dental crown 10 includes an inner surface 16, of FIG. 2, and an outer surface 18. Crown 10 may be substantially composed of only zirconia which has been treated to closely follow the color and appearance of a natural tooth. For example, zirconia powders may be employed possessing shade variations and degrees of translucence. Further, hardened zirconia may be combined with typical metal oxide stabilizers such as yttria, ceria, and india, calcium oxide and the like. Such stabilization is believed to increase the strength of pure zirconia by presenting formation of a monoclinic crystal link Inner surface 16, takes the form of a hollowed out area which is intended to fit the stub 12 of the natural tooth. In addition, the interior surface 16 of crown 10 includes a plurality of holes or pits 20 which create interstices to accept cementitious material when the crown 10 is eventually placed over tooth stub 12 and allowed to set.

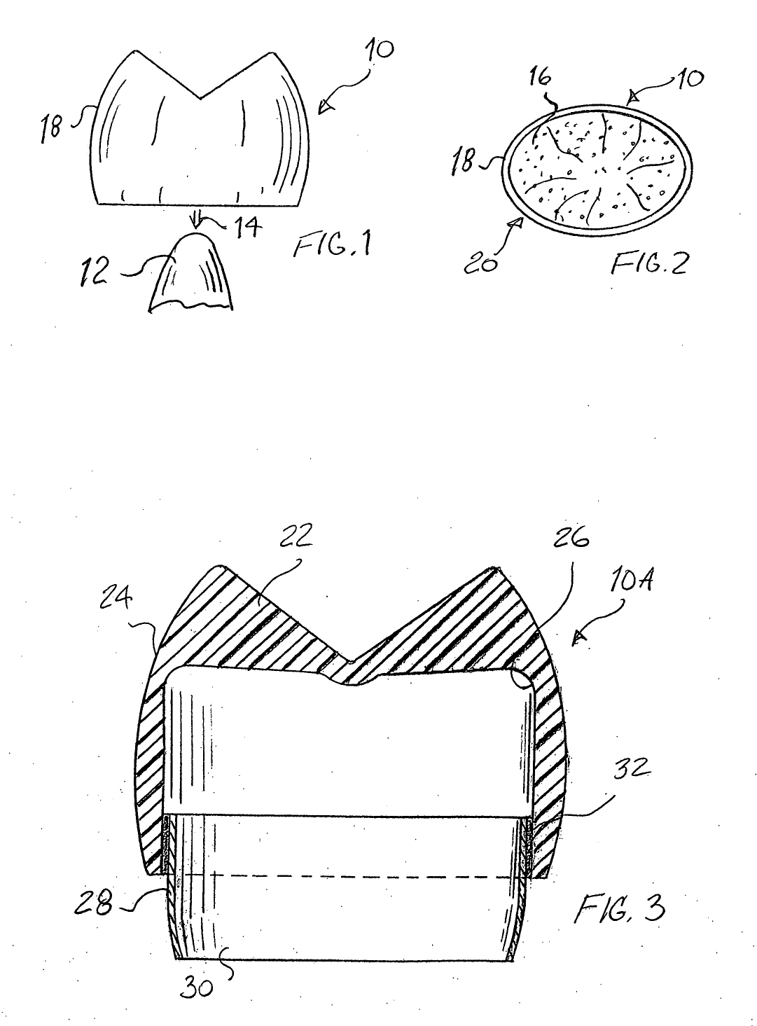

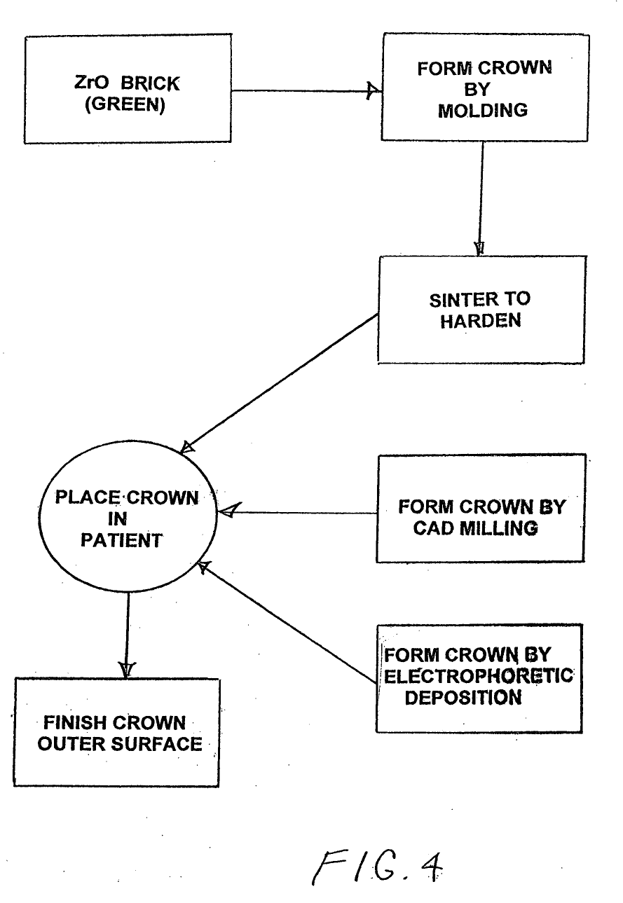

With respect to FIG. 3, another embodiment 10A of the present invention is depicted. 10A includes a crown 22 formed similarly to crown 10 of FIGS. 1 and 2, namely being composed substantially of pure zirconia. Crown 22 includes an outer surface 24 and an inner surface 26. In addition, embodiment 10A is formed with a band or sleeve 28 which is flexible. The edge portion 30 of sleeve 28 may be cut and/or crimped to fit cervical margins during preparation of the natural tooth. Sleeve 28 may be formed of any suitable material such as metal, plastic, and the like. For example, stainless steel may be employed in this regard. Sleeve 28 is bonded to inner surface 26 of crown 22 via an adhesive layer 32. Adhesive layer 32 may consist of Panavia F or other suitable bonding agents. Normally, embodiment 10A of the present invention would be employed in the rear teeth of a patient, while the embodiment 10, depicted in FIGS. 1 and 2, would be used on the front teeth of a patient.

It should be realized that crowns 10 or 10A of the present invention may be formed by various methods. For example, turning to FIG. 4, it may be observed that with respect to molding zirconia crowns 10 or 10A, the starting material exists in a brick form which is chalky in consistency and is often referred to as “green” zirconia. Zirconia is then placed in a mold which includes a structure to form internal pits or holes as is shown on FIG. 2. The molded crown 10, 10A is then subjected heat (1000° C.) and several atmospheres of pressure to harden to the same through sintering. In certain cases, crown 10 made of zirconia may be formed by CAD aided milling of pre-hardened zirconia, or through electrophoretic or ultrasonic processes. In other words, crowns 10 or 10A may be formed by any of several processes. Prior to placement of crown 10 or 10A into the mouth of a patient, crown 10 or 10A may be polished with an abrading substance such as a diamond paste to achieve a natural appearance. A pre-finish step may be applied to crown 10 or 10A to remove surface irregulations.

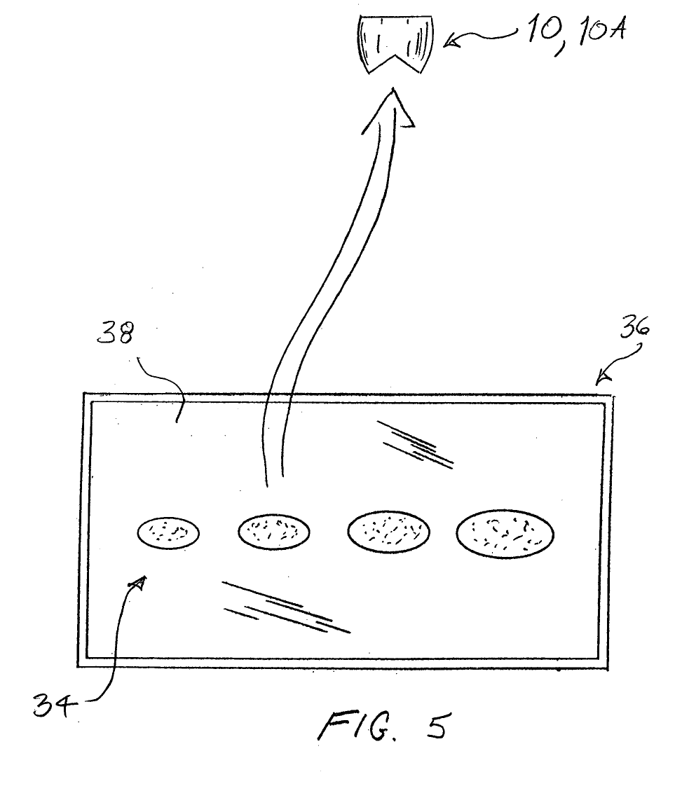

FIG. 5, represents a kit 36 in which a plurality of zirconia crowns 34, fabricated according to the present invention, and of various sizes are displayed on tray 38. The dental practitioner may select a particular crown 10, 10A for a particular use and insert the same over the stub 12, FIG. 1, of the natural tooth quickly and easily without taking a mold of each and every pre-existing tooth to be crowned and milling a new tooth through a CAD/CAM process, or the like. It should be realized that the system of the present invention saves time and is more economical than the prior methods found in the pedodontic and veterinarian fields.

The following Examples are intended to illustrate the invention of the present application but are not deemed to limit the scope of the invention in any manner.

### EXAMPLE I

The shape of a natural tooth was designed in CAD. From such design, a hardened zirconia block was milled to produce a crown which mimicked a natural tooth. The zirconia block consisted of pure zirconia stabilized by yttria sold under the designation “ZS-blank” by Kabo Dental Corporation, Lake Zurich, Ill. Following such production of the crown, it was pre-polished by applying a diamond impregnated silicon wheel (CERAGLAZE 1, NTI Axis Dental) to remove all surface irregularities. A final polish was achieved with a Robinson brush/wheel and a 40 millimicron diamond paste. (Frontier Dental Laboratories, El Dorado Hills, Calif.)

### EXAMPLE II

A crown prepared according to Example I was placed in the mouth of a child patient. A dental practitioner prepared the natural tooth using standard guidelines for primary dentition to allow the patient to receive the pre-fabricated crown of Example I. That is to say, a stub similar to stub 12 of FIG. 1 was created. The prepared zirconia crown was of the proper size having an acceptable mesiodistal width. The fit of the crown was evaluated and possible tissue impingement was determined. Extension of gingival margin was trimmed with a fine diamond wheel on slow speed with a copious water spray. The crown was filled with glass ionomer to cement the same to the natural stub of the tooth. It should be realized that self-cure composite resin cement may have also been used in this regard. The crown was then seated in the mouth completely. Practitioner then checked and adjusted occlusion. Finally, the final polish was applied to the crown using a diamond impregnated silicon wheel.

### EXAMPLE III

To attain a natural appearance of the crown of Examples I and II, a pre-polish was applied to all external surfaces to remove surface irregularities. A diamond impregnated silicon wheel (CERAGLAZE I, NTI Axis Dental) was employed. After such pre-polish, a final polish was accomplished by using a Robinson brush wheel with 40 ml diamond paste (Frontier Dental Laboratories of Eldorado Hills of Calif.). The finished dental crown appeared to very closely resemble, on an esthetic basis, the natural tooth of a human.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

1. A system for providing a dental crown for a natural tooth that is especially useful in pedodontic and veterinary applications, comprising:
at least one crown formed of, substantially, zirconia (ZrO₂).

2. The system of claim 1 in which said one crown includes an outer surface and an open chamber, said open chamber including an inner surface and including apertures formed on said inner surface.

3.-6. (canceled)

7. The system of claim 1 in which said at least one crown further comprises a plurality of crowns of various sizes.

8. The system of claim 1 in which additionally comprises a sleeve, and an adhesive for holding said sleeve to said crown.

9. The system of claim 1 in which said one crown includes an outer surface, said outer surface including a polished finish.

10. The system of claim 9 in which said polished finish is pearlescent.

11. The system of claim 1 in which said crown formed of, substantially, zirconia consisting essentially of zirconia and a stabilizer.

12. A method for providing a dental crown for a natural tooth, the method comprising the steps of:
preparing a tooth for receiving a dental crown;
selecting a dental crown from a kit of prefabricated crowns comprising a plurality of prefabricated dental crowns of various sizes wherein the dental crowns are formed of, substantially, zirconia (ZrO₂);
applying a cement to the dental crown; and
seating the dental crown on the tooth.

13. The method of claim 12 in which the selected dental crown includes an outer surface and an open chamber, the open chamber including an inner surface and including apertures formed on the inner surface, the apertures cooperating with the cement to fix the dental crown to the tooth.

14. The method of claim 12 in which the prefabricated crowns comprise a sleeve and an adhesive for holding said sleeve to said crown.

15. The method of claim 12 wherein the prefabricated crowns have a pearlescent finish.

16. The method of claim 12 wherein the prefabricated crowns formed of, substantially, zirconia consisting essentially of zirconia and a stabilizer.

17. The method of claim 12 wherein the tooth is a child's tooth.

18. The method of claim 12 wherein the tooth is a veterinary tooth.

19. A method for forming a kit of crowns, the method comprising the step of:
forming a plurality of dental crowns of various sizes of, substantially, zirconia (ZrO₂).

20. The method of claim 19 further comprising forming a pearlescent finish on an outer surface of the plurality of dental crowns comprising:
pre-polishing an outer surface with a diamond impregnated silicon wheel; and
final polishing the outer surface with a diamond paste.

21. The method of claim 19 wherein the prefabricated crowns formed of, substantially, zirconia consisting essentially of zirconia and a stabilizer.

22. The method of claim 19 wherein the step of forming a plurality of dental crowns is by a molding process.

23. The method of claim 19 wherein the step of forming a plurality of dental crowns is by a milling process.

24. The method of claim 19 wherein the step of forming a plurality of dental crowns is by an electrophoretic process.

25. The method of claim 19 wherein the step of forming a plurality of dental crowns is by an ultrasonic process.
